(19) United States
(12) Patent Application Publication
(10) Pub. No.: US 2021/0270200 A9
(43) Pub. Date: Sep. 2, 2021

(54) GAS SENSOR

(71) Applicants: DENSO CORPORATION, Kariya-city (JP); TOYOTA JIDOSHA KABUSHIKI KAISHA, Toyota-shi (JP)

(72) Inventors: Toru TAKEUCHI, Kariya-city (JP); Tomotaka MORI, Kariya-city (JP); Shota IMADA, Kariya-city (JP); Yoshiharu MIYAKE, Miyoshi-shi (JP); Hiroki NISHIJIMA, Nisshin-shi (JP); Haruki KONDO, Okazaki-shi (JP); Yasushi HIRATA, Toyota-shi (JP)

(21) Appl. No.: 16/860,361

(22) Filed: Apr. 28, 2020

Related U.S. Application Data
(63) Continuation of application No. PCT/JP2018/040132, filed on Oct. 29, 2018.

(30) Foreign Application Priority Data
Oct. 31, 2017 (JP) 2017-210404

(51) Int. Cl. F02D 41/14; G01N 27/407

(52) U.S. Cl. CPC F02D 41/1494; G01N 27/4071; F02D 41/1454

(57) ABSTRACT

A gas sensor includes a sensor element body having a porous layer provided on an outer surface, and a power supply device which supplies power to a heater element that is in the sensor element body. The amount of power being applied to the heater element by the power supply device when gas detection is being performed by the gas sensor in a steady state is designated as P [W], the volume of the length range of a heating region of the heater element provided in the sensor element body as V [mm³], and the applied power density as X [W/mm³], where X is a value expressed by P/V. In that case, the following relationship is satisfied between the applied power density X and the average thickness Y [μm] of the porous layer:

Y≥509.32−2884.89X+5014.12X²

### CROSS-REFERENCE TO RELATED APPLICATION

This application is a U.S. application under 35 U.S.C. 111(a) and 363 that claims the benefit under 35 U.S.C. 120 from International Application No. PCT/JP2018/040132 filed on Oct. 29, 2018, the entire contents of which are incorporated herein by reference. This application is also based on Japanese Patent Application No. 2017-210404 filed on Oct. 31, 2017, whose contents are incorporated herein by the reference.

### BACKGROUND

### Technical Field

The present disclosure relates to a gas sensor.

### Background Art

A gas sensor is used for example to detect the concentration of oxygen, or the concentration of a specific gas component, in exhaust gas from an internal combustion engine. A laminated sensor element body, in which are integrated a solid electrolyte layer provided with a detection electrode and a reference electrode, and a heater element that generates heat when energized, is often used as a gas sensor. Furthermore, a detection gas chamber having a detection electrode disposed therein, and a diffusion resistance layer for introducing a detection gas into the detection gas chamber, are formed adjacent to one another on one of the main surfaces of the solid electrolyte layer in the sensor element body.

The sensor element body is provided with a porous layer that covers at least the exposed surface of the diffusion resistance layer or covers the entire periphery including the exposed surface of the diffusion resistance layer.

### SUMMARY

One aspect of the present disclosure is a gas sensor that comprises:

a sensor element body comprising a solid electrolyte layer, a detection electrode, a reference electrode, a diffusion resistance layer, a heater element that is embedded in the insulating layers and that generates heat when energized, and a porous layer that covers at least an exposed surface of the diffusion resistance layer; and

a power supply device for energizing the heater element;

wherein when gas detection is being performed by the gas sensor in a steady state, designating the amount of power being applied to the heater element by the power supply device as P [W], the volume of the part of the sensor element body that is in the length range of a heating region as V [mm³], and the applied power density as X [W/mm³], where X is a value expressed by P/V, the following relationship between the applied power density X and the average thickness Y [μm] of the porous layer is satisfied

Y≥509.32−2884.89X+5014.12X²

It should be noted that, although the reference signs in parentheses of respective components shown in an embodiment of the present disclosure indicate a correspondence with the reference signs appearing in the drawings of the embodiments, the components are not limited only to the contents of the embodiments.

### BRIEF DESCRIPTION OF THE DRAWINGS

The objectives, features, advantages, etc., of the present disclosure will become more apparent from the following detailed description, given with reference to the accompanying drawings. The drawings of the present disclosure are shown below.

FIG. 1 is an explanatory cross-sectional view showing a gas sensor according to an embodiment.

FIG. 2 is an exploded perspective view showing a sensor element body according to the embodiment.

FIG. 3 is a cross-sectional view showing the sensor element body according to the embodiment.

FIG. 4 is an explanatory diagram showing a length range in which a heating region of a heater element is provided in the sensor element body according to the embodiment.

FIG. 5 is a perspective view showing the heating region of the heater element according to the embodiment.

FIG. 6 is a perspective view showing the heating region of another heater element according to the embodiment.

FIG. 7 is a cross-sectional view showing another sensor element body according to the embodiment.

FIG. 8 is a graph showing a first relational expression between applied power density and the average thickness of a porous layer according to the embodiment.

FIG. 9 is a graph showing first to fourth relational expressions between the applied power density and the average thickness of the porous layer according to the embodiment.

### DETAILED DESCRIPTION OF THE PREFERRED EMBODIMENTS

A preferred embodiment of the above-mentioned gas sensor will be described referring to the drawings.

The inventor of the present disclosure has studied a gas sensor whereby an index can be used that enables determination of a value of thickness of a porous layer, in relation to applied power density, which is the minimum allowable thickness for maintaining a high accuracy of detection for following reasons.

As mentioned above, a sensor element body is usually provided with a porous layer that covers at least the exposed surface of the diffusion resistance layer or covers the entire periphery including the exposed surface of the diffusion resistance layer. The porous layer serves to protect the electrode from substances that are poisonous to it, water, etc., or for protecting the sensor element body from scattered water. Examples of gas sensor elements corresponding to such a laminated sensor element body, are described in JP 2011-117935 A and JP 2016-48230 A

In the gas sensor element of JP 2011-117935 A, since the surface protective layer (porous layer) has water repellency at the high temperature at which the solid electrolyte layer is activated, a thickness of the surface protective layer in the range of 20 to 150 μm is described. Furthermore, the gas sensor element of JP 2016-48230 A is described as having a porous protective layer (porous layer) formed in a region of a laminated body which is set at a temperature state of 500° C. or more when the temperature is controlled by a heater.

With the conventional gas sensors or gas sensor elements described in Patent JP 2011-117935 A, JP 2016-48230 A., etc., the thickness of the porous layer is determined based on in consideration of early activation of the gas sensor element, preventing generation of cracking due to being wetted, etc. However, the essential performance requirements of a gas sensor include detection accuracy and responsiveness, as sensor output characteristics. This detection accuracy is affected by the temperature of the detection section, which includes the electrodes and the parts of the solid electrolyte layer that are sandwiched between the electrodes in the sensor element body. In general, as the temperature of the detection section increases, the decomposition reactions of oxygen and the like in the detection section are promoted, and the detection accuracy and the responsiveness tend to increase.

The temperature of the detection section varies in accordance with the heat balance between the amount of heat received by the detection section and the amount of heat released from the detection section, and in particular, the amount of heat received by the detection section is affected by the applied power density applied to the detection section from the heating section of the heater element. The input power density is a value obtained by dividing the amount of power inputted to the heater element by the volume of that part of the sensor element body which is within the range of length where the heating region of the heater element is provided. On the other hand, the rate at which heat is released from the detection section is particularly affected by evaporation heat (heat of vaporization) when the porous layer covering the detection section becomes wetted, and water adhering to the surface of the porous layer evaporates.

Since the heat capacity decreases as the thickness of the porous layer decreases, it might be thought that the amount of electric power supplied to the heater element for setting the temperature of the detection section to the target temperature could be reduced by decreasing the thickness. However, it is necessary to take into consideration that the smaller the thickness of the porous layer, the more readily will the detection section be affected by the heat of evaporation, and the greater will be the amount of heat released from the detection section. Hence the smaller the thickness of the porous layer, the greater must be the amount of electric power applied to the heater element for maintaining the temperature of the detection section at the target temperature.

Furthermore, it is necessary to take into consideration that the responsiveness of the gas sensor deteriorates as the thickness of the porous layer increases, due to the fact that it becomes difficult for the detection gas to reach the detection section. Hence in order to keep the responsiveness of the gas sensor high, there is also a requirement that the thickness of the porous layer be reduced as far as possible. However, as a result of research by the inventors it has been found that when the thickness of the porous layer is excessively small, it is difficult to set the temperature of the detection section to the target temperature, and there is a deterioration in the detection accuracy of the gas sensor.

In order to determine the magnitude of the applied power, it is necessary to consider the causes of the above-mentioned contradictions between the heat capacity and the heat of evaporation. As a result of the research performed by the inventors, it has been found that there is a complex relationship between the applied power and the thickness of the porous layer, which is outside a range that could be predicted by persons skilled in the art.

With a conventional gas sensor or gas sensor element, the extent to which the thickness of the porous layer can be reduced in relation to the applied power is unknown. Hence, it has come to be understood that in order to properly maintain the temperature of the detection section and also maintain a high level of detection accuracy of the gas sensor, it is necessary to have an index that can be used to appropriately determine the applied power amount and the thickness of the porous layer.

The present disclosure has an objective of providing a gas sensor whereby an index can be used that enables determination of a value of thickness of a porous layer, in relation to applied power density, which is the minimum allowable thickness for maintaining a high accuracy of detection.

One aspect of the present disclosure is a gas sensor that comprises:

a sensor element body comprising a solid electrolyte layer, a detection electrode provided on a first main surface of the solid electrolyte layer, a reference electrode provided on a second main surface of the solid electrolyte layer, a detection gas chamber that is formed adjacent to the first main surface of the solid electrolyte layer such as to contain the detection electrode therein, a diffusion resistance layer that is laminated on the solid electrolyte layer for introducing a detection gas into the detection gas chamber, insulating layers that are laminated on the solid electrolyte layer, a heater element that is embedded in the insulating layers and that generates heat when energized, and a porous layer that covers at least an exposed surface of the diffusion resistance layer; and

a power supply device for energizing the heater element;

wherein when gas detection is being performed by the gas sensor in a steady state, designating the amount of power being applied to the heater element by the power supply device as P [W], the volume of the part of the sensor element body that is in the length range of a heating region of the heater element provided in the sensor element body as V [mm³], and the applied power density as X [W/mm³], where X is a value expressed by P/V, the following relationship between the applied power density X and the average thickness Y [μm] of the porous layer is satisfied

Y≥509.32−2884.89X+5014.12X²

A gas sensor according to the above aspect provides an index of how large the average thickness Y of the porous layer should be, in relation to the applied power density X that is supplied to the heater element from the power supply device. This index is expressed by a relational expression between the applied power density X and the average thickness Y of the porous layer. The relational expression also takes into account that the porous layer becomes wetted, and is derived through experiments or through simulation.

The relational expression defines a limit to the extent that the average thickness Y of the porous layer can be reduced in relation to the applied power density X while maintaining accuracy of detection by the gas sensor. When the applied power density X and the average thickness Y of the porous layer satisfy the above-described relational expression, the temperature of the detection section, including the electrodes and the part of the solid electrolyte layer that is sandwiched between the electrodes in the sensor element body, can be appropriately maintained. The detection accuracy of the gas sensor can thereby be held at a high level.

Details will be given in an embodiment described hereinafter, however the above-described relational expression is not simple. The relational expression combines a relationship whereby the required average thickness Y of the porous layer increases as the applied power density X decreases and a relationship whereby the required value of average thickness Y of the porous layer increases as the applied power density X increases. It was confirmed that there is a value of the applied power density X that is appropriate for maintaining the temperature of the detection section while enabling the average thickness Y of the porous layer to be reduced.

With a gas sensor according to the above aspect, an index is provided which enables the minimum allowable value of thickness of the porous layer in relation to the applied power density to be determined, while maintaining a high accuracy of detection by the gas sensor.

Gas detection by a gas sensor has various applications, and utilizes the difference in oxygen concentration, or in a specific gas component concentration, between a detection electrode and a reference electrode. Examples of uses for gas detection include applications for detecting whether the air-fuel ratio of an internal combustion engine, as determined from the composition of the exhaust gas, is on the fuel rich side or on the fuel lean side in relation to the stoichiometric air-fuel ratio, applications for quantitatively detecting the air-fuel ratio of an internal combustion engine from the exhaust gas of the engine, and applications for obtaining the concentration of NOx components in the exhaust gas, etc.

The steady state in which gas detection is performed can be said to be a state in which the detection section is being maintained at the activation temperature as the target temperature, as opposed to a transient state in which the temperature of the detection section in the sensor element body is changing from the normal temperature to the activation temperature, when operation of the gas sensor is started. In other words, the steady state can be said to be a state in which the temperature of the detection section is in equilibrium at the target temperature.

The target temperature of the detection section may be set in the range 600 to 800° C.

By setting the amount of electric power applied by the power supply device as the input power density, the value of the input power amount can be determined by taking into consideration the volume of the sensor element body within the length range in which the heating region of the heat generating element is provided. In order to maintain the applied power density, it is necessary to increase the applied power amount in accordance with any increase in volume of the part of the sensor element body that is within the length range in which the heating region is provided.

The “heating region of the heater element” refers to a region, other than the connecting leads of the heater element, in which the heating section of the heater element is disposed in a meandering configuration. “The length range of the sensor element body in which the heating region of the heat generating element is provided” refers to the length of the part of the sensor element body in which the heating region is provided, as measured along the longest one of the plurality of sides of the sensor element body. The volume of this length range can be considered as the volume of the part of the sensor element body that extends between respective ends of the range in which the heating region is provided in the sensor element body, with respect to the longitudinal direction, when that part is cut out as a block in a direction orthogonal to the longitudinal direction. The volume of the length range includes the volume of the part of the porous layer that is within the length range.

The thickness of the porous layer may differ depending upon the part of the sensor element body where the porous layer is provided. The average thickness of the porous layer, as specified in the above relational expression, is the average value of thickness of the entire porous layer. This average thickness ideally can be taken as the thickness of a porous layer which has a uniform thickness and has the same volume as the entire volume of the porous layer which is on the sensor element body and which consists of portions disposed at respective positions and having different thicknesses. Actually, the average thickness can be obtained by measuring the respective values of thickness of a plurality of portions of the porous layer having different thicknesses, and taking the average value of the thicknesses of the plurality of portions. The thickness measurement may be performed, for example, at 10 to 100 positions in the sensor element body where there are different values of thickness.

### Embodiment

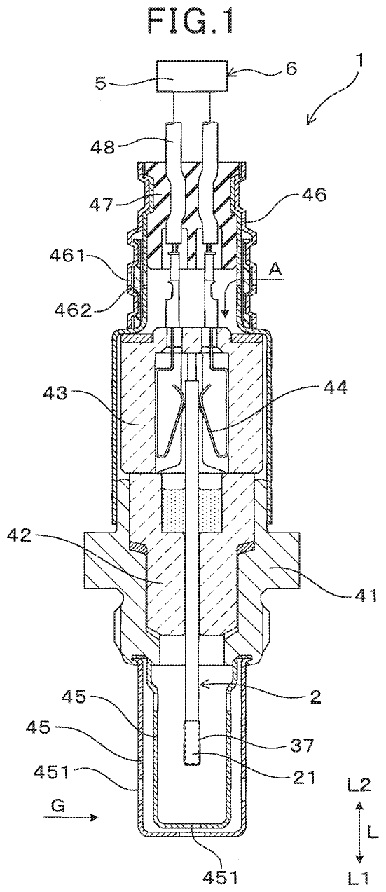

As shown in FIGS. 1 to 3, the gas sensor 1 of the present embodiment includes a sensor element body 2 and a power supply device 5 that supplies power to a heater element 34 of the sensor element body 2. The sensor element body 2 includes a solid electrolyte layer 31, a detection electrode 311, a reference electrode 312, a detection gas chamber 35, a diffusion resistance layer 32, insulating layers 33A and 33B, a heater element 34, and a porous layer 37.

The solid electrolyte layer 31 has conductivity to oxygen ions (oxide ions) at a predetermined activation temperature. The detection electrode 311 is disposed on a first main surface 301 of the solid electrolyte layer 31, as an electrode that is exposed to a detection gas G. The reference electrode 312 is provided on a second main surface 302 of the solid electrolyte layer 31. The first main surface 301 and the second main surface 302 refer to the surfaces (flat surfaces) of the plate-like solid electrolyte layer 31 that have the largest surface area.

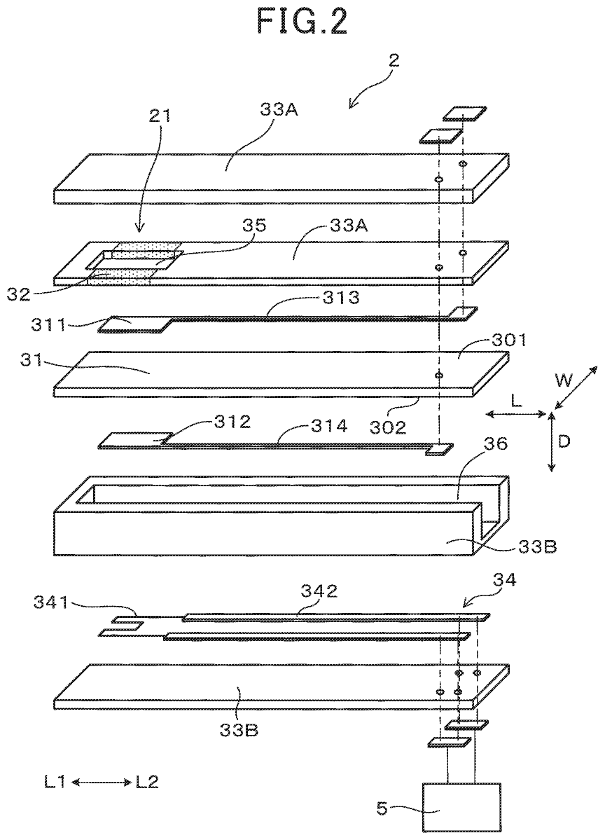

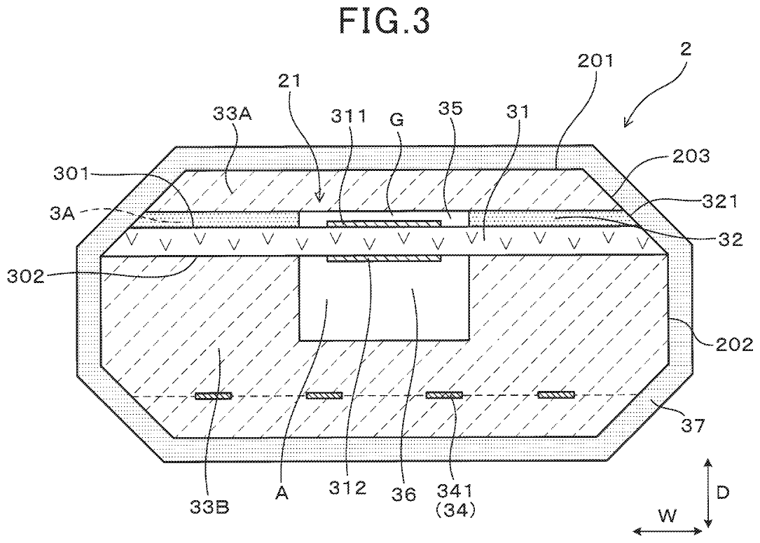

As shown in FIGS. 2 and 3, the detection gas chamber 35 is formed adjacent to the first main surface 301 of the solid electrolyte layer 31, and is surrounded by the insulating layer 33A such that the detection electrode 311 is disposed therein. The diffusion resistance layer 32 is laminated on the solid electrolyte layer 31, and serves to introduce the detection gas G into the detection gas chamber 35 at a predetermined diffusion rate. The insulating layers 33A and 33B are layers having an insulating property, and are laminated on the first main surface 301 and the second main surface 302 of the solid electrolyte layer 31. The heater element 34 is embedded within the insulating layer 33B, and generates heat when energized. The porous layer 37 is provided on the outer surface of the sensor element body 2 at a position covering at least the exposed surface 321 of the diffusion resistance layer 32. The power supply device 5 energizes (supplies power to) the heater element 34.

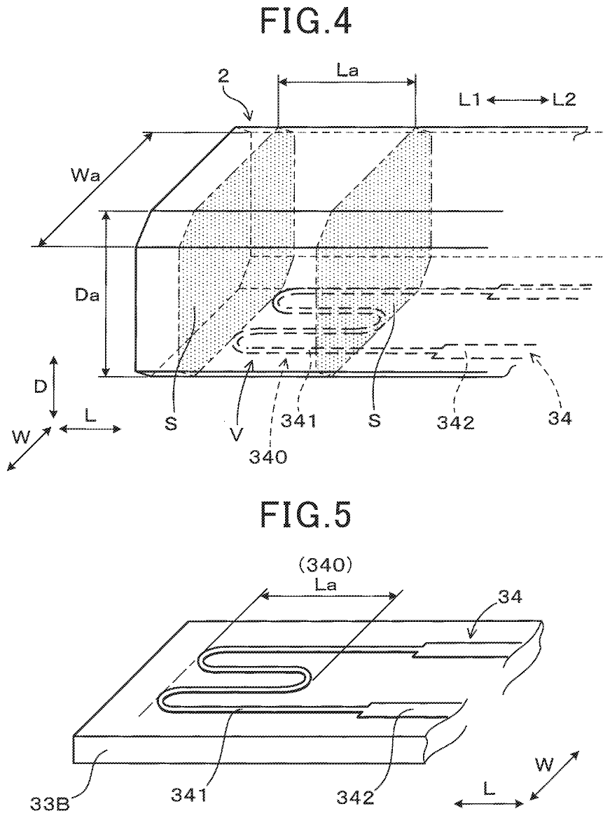

The applied power amount supplied to the heater element 34 by the power supply device 5 when gas detection is being performed by the gas sensor 1 in a steady state will be designated as P [W], and the volume of the length range (La) in which the heating region 340 of the heater element 34 is provided, in the sensor element body 2 as shown in FIG. 4, will be designated as V [mm³]. In that case the applied power density X [W/mm³] takes a value expressed as X=P/V. As shown in FIG. 8, the applied power density X and the average thickness Y [μm] of the porous layer 37 satisfy the first relational expression R1:

Y≥509.32−2884.89X+5014.12X²

The gas sensor 1 of the present embodiment will be described in detail in the following.

### (Internal Combustion Engine)

As shown in FIG. 1, the gas sensor 1 of the present embodiment is attached to an exhaust pipe through which flows the exhaust gas from an internal combustion engine (engine) of a vehicle. The gas sensor 1 performs gas detection using the exhaust gas flowing in the exhaust pipe as the detection gas G and using atmospheric air as the reference gas A. The gas sensor 1 of the present embodiment is used as an air-fuel ratio sensor for obtaining the air-fuel ratio of an internal combustion engine, with the air-fuel ratio being derived from the composition of the exhaust gas. In the following, the air-fuel ratio of an internal combustion engine as determined by the gas sensor 1 may be referred to as the air-fuel ratio of the exhaust gas.

The air-fuel ratio sensor can continuously quantitatively detect the air-fuel ratio, in a range from a fuel-rich state, in which the ratio of fuel to air is higher than the stoichiometric air-fuel ratio, to a fuel-lean state, in which the ratio of fuel to air is lower than the stoichiometric air-fuel ratio. In the air-fuel ratio sensor, a predetermined voltage is applied between the detection electrode 311 and the reference electrode 312, for exhibiting the limit current characteristic of the current that is outputted in accordance with the amount of movement of oxygen ions, when the flow rate of the detection gas G that is guided to the detection gas chamber 35 by the diffusion resistance layer 32 is reduced.

The internal combustion engine for which the air-fuel ratio is detected by the gas sensor 1 is a multi-cylinder reciprocating engine such as a four-cylinder, six-cylinder, or eight-cylinder engine. The air-fuel ratio values detected by the gas sensor 1 are used by the control unit of the reciprocating engine to control the air-fuel ratio in each of the cylinders to a target air-fuel ratio. The timings at which the four strokes of intake, compression, combustion, and exhaust occur in each cylinder are made appropriately different, and the exhaust gas is outputted from respective cylinders to the exhaust pipe at different timings.

The gas sensor 1 uses the exhaust gas outputted from each cylinder to the exhaust pipe as the detection gas G, in a predetermined sequence. In order to obtain the air-fuel ratio in each cylinder it is necessary for the engine control unit to determine, for each air-fuel ratio obtained by the gas sensor 1, the cylinder which outputted the exhaust gas whose air-fuel ratio was detected. The variation in air-fuel ratio between respective cylinders of an internal combustion engine is generally referred to as the inter-cylinder imbalance.

On the other hand, the ability of the gas sensor 1 to detect the air-fuel ratio of exhaust gas outputted from each cylinder separately from the air-fuel ratios of the exhaust gas outputted from the other cylinders is referred to as the accuracy of detecting the inter-cylinder imbalance. The detection accuracy of the gas sensor 1 of the present embodiment refers to the accuracy of detecting the inter-cylinder imbalance. The first relational expression R1 between the applied power density X and the average thickness Y of the porous layer 37, with the present embodiment, is an index for determining the minimum allowable value of the average thickness Y of the porous layer 37 that will maintain a predetermined accuracy of detecting the inter-cylinder imbalance.

A three-way catalyst is disposed in the exhaust pipe, for purifying HC (hydrocarbon), CO (carbon monoxide) and NOx (nitrogen oxides) contained in the exhaust gas. The engine control unit uses the air-fuel ratios from the gas sensor 1 to control the air-fuel ratio in each cylinder of the internal combustion engine, such as to maintain the air-fuel ratio close to the stoichiometric air-fuel ratio, which is the air-fuel ratio at which the catalytic activity of the three-way catalyst is effectively exhibited. The gas sensor 1 of the present embodiment is disposed in the exhaust pipe at a position that is upstream from the three-way catalyst in the exhaust gas flow.

It should be noted that the gas sensor 1 can be used as an oxygen sensor that judges, from the composition of the exhaust gas, in an on/off manner, whether the air-fuel ratio of the internal combustion engine is on the fuel lean side or the fuel rich side, based on the difference in oxygen concentration between the detection gas G that contacts the detection electrode 311 and the reference gas A that contacts the reference electrode 312. In that case, the gas sensor 1 can be disposed in the exhaust pipe at a position downstream from the position of the three-way catalyst, in the exhaust gas flow.

The gas sensor 1 can also be used as a NOx sensor that detects NOx as a specific gas component in the exhaust gas.

When the gas sensor 1 is used as an oxygen sensor also, improving the accuracy of detecting the inter-cylinder imbalance is effective, for distinguishing and detecting the oxygen concentrations in respective cylinders. Furthermore, when the gas sensor 1 is used as a NOx sensor also, improving the accuracy of detecting the inter-cylinder imbalance is effective, for distinguishing and detecting the NOx concentrations in respective cylinders.

### (Sensor Element Body 2)

As shown in FIGS. 2 and 3, the sensor element body 2 is a laminated type, in which the solid electrolyte layer 31 is sintered with the insulating layers 33A and 33B and the heater element 34 in a laminated condition. The solid electrolyte layer 31 has zirconia as a main component, and is formed of stabilized zirconia or of partially stabilized zirconia in which a part of zirconia is substituted by a rare earth metal element or an alkaline earth metal element. The solid electrolyte layer 31 can be formed of yttria stabilized zirconia or yttria partially stabilized zirconia. The detection electrode 311 and the reference electrode 312 contain platinum as a noble metal exhibiting catalytic activity for oxygen, and a solid electrolyte whose material is common to that of the solid electrolyte layer 31.

The sensor element body 2 is formed in an elongated shape, with the detection electrode 311, the reference electrode 312, the detection gas chamber 35, the diffusion resistance layer 32, and the heating region 340 of the heater element 34 being located at the tip end with respect to the longitudinal direction L. The detection section 21 is formed by the detection electrode 311, the reference electrode 312, and a part of the solid electrolyte layer 31 sandwiched between the detection electrode 311 and the reference electrode 312, at the tip end of the sensor element body 2 with respect to the longitudinal direction L.

The “longitudinal direction L” of the sensor element body 2 refers to the direction along which the sensor element body 2 is formed in an elongated shape. A direction orthogonal to the longitudinal direction L, and in which the solid electrolyte layer 31, the insulating layers 33A and 33B, and the heater element 34 are stacked, is referred to as the lamination direction D. The direction orthogonal to the longitudinal direction L and the lamination direction D is referred to as the width direction W. In FIGS. 1 to 4, the tip end with respect to the longitudinal direction L is indicated as L1 and the base end with respect to the longitudinal direction L is indicated as L2.

As shown in FIG. 2, electrode leads 313 and 314 are connected to the detection electrode 311 and the reference electrode 312, for connecting the electrodes 311 and 312 to the exterior of the gas sensor 1, with the electrode leads 313 and 314 being led out along the longitudinal direction L to a position at the base end.

The heater element 34 includes a heating section 341 that generates heat when energized, and a pair of heater element leads 342 that are connected to the heating section 341. The heater element leads 342 are led out along the longitudinal direction L to a part at the base end.

The heater element 34 contains a metal material that is electrically conductive.

As shown in FIG. 2, the heating section 341 is formed in a shape that meanders in the longitudinal direction L, at a tip end portion of the heater element 34. The heating section 341 is positioned facing the detection electrode 311 with respect to the lamination direction D, which is orthogonal to the longitudinal direction L, and heats the solid electrolyte layer 31, the detection electrode 311, the reference electrode 312 and the insulating layers 33A and 33B, etc., such as to bring the detection electrode 311 to a target temperature.

The cross-sectional area of the heating section 341 is smaller than that of the heater element part lead 342, and the resistance value of the heating section 341 per unit length is higher than that of the heater element lead 342. The term “cross-sectional area” here refers to the cross-sectional area of a surface that is orthogonal to the direction in which the heating section 341 and the heater element leads 342 extend. When a voltage is applied to the pair of heater element leads 342 by the power supply device 5, the heating section 341 generates heat by Joule heating, and the periphery of the detection section 21 is heated thereby.

The “heating region 340 of the heater element 34” means a region in which the heating section 341 is disposed in a meandering form, or in other words, a region in which three or more heating sections 341 are arranged adjacent to one another in the longitudinal direction L or the width direction W. The heating section 341 may be formed such as to meander in the width direction W, instead of meandering in the longitudinal direction L. The “heating region 340” means a region in which the temperature becomes high due to energization of the heater element 34.

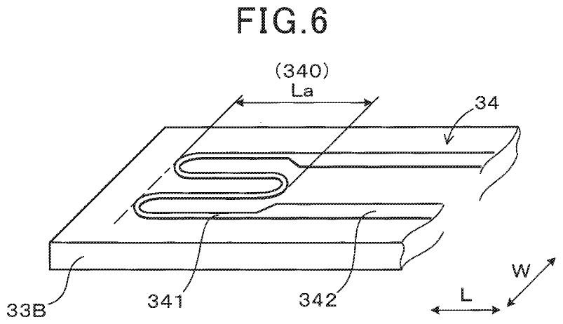

As shown in FIG. 5, the region in which the heating section 341 is disposed in a meandering manner may be shorter than the length of the heating section 341 along the longitudinal direction L. Alternatively as shown in FIG. 6, the region in which the heating section 341 is disposed in a meandering manner may have substantially the same length, in the longitudinal direction L, as the heating section 341.

As shown in FIG. 4, the length range La in which the heating region 340 of the heat generating element 34 is provided is a part of the length of the sensor element body 2 in the longitudinal direction L. The volume V of the length range La in which the heating region 340 is disposed in the sensor element body 2 is defined as the volume of a block consisting of a part of the sensor element body 2 that includes the heater element 34, extending along the longitudinal direction L as longitudinal direction of sensor element body 2 between the two ends of the longitudinal range in which the heating region is provided, cut out in planes S that are orthogonal to the longitudinal direction L. The volume V of the length range La includes the volume of the porous layer 37 that is within the length range La.

The applied power density X applied by the power supply device 5 is determined with the assumption that the amount of applied power P applied to the heater element 34, or in other words, the heat generated by the heating region 340 of the heater element 34 is used for heating the portion of the sensor element body 2 that is within the length range La in which the heating region 340 is provided.

As shown in FIG. 4, designating La [mm] as the length of the heating region 340 provided in the sensor element body 2 in the lengthwise direction L , designating Wa [mm], as the width (length) of the sensor element body 2 in the width direction W, and designating Da [mm] as the thickness (length) of the sensor element body 2 in the lamination direction D, the volume V is determined based on La×Wa×Da. When corners 22 having a cross section orthogonal to the longitudinal direction L of the sensor element body 2 have been removed as cut-out portions, the volume V can be obtained by subtracting, from La×Wa×Da, the volume of those parts of the cutout portions which are within the range of the length La.

The insulating layers 33A and 33B are laminated on both the first main surface 301 and the second main surface 302 of the solid electrolyte layer 31. The first insulating layer 33A is laminated on the first main surface 301 of the solid electrolyte layer 31 to form the detection gas chamber 35, and the second insulating layer 33B is laminated on the second main surface 302 of the solid electrolyte layer 31 to form the air duct 36 and to bury the heater element 34. The first and second insulating layers 33A and 33B are formed of an insulating metal oxide such as alumina.

The first and second insulating layers 33A and 33B are formed as dense layers that are non-porous and do not allow passage of a gas such as the detection gas G or the reference gas A.

As shown in FIGS. 2 and 3, the detection gas chamber 35 is formed by being surrounded by the first main surface 301 of the solid electrolyte layer 31, the first insulating layer 33A, and the diffusion resistance layer 32. The diffusion resistance layer 32 of the present embodiment is positioned facing the first main surface 301 of the solid electrolyte layer 31 and opposite both sides of the detection gas chamber 35 in the width direction W, which is orthogonal to the longitudinal direction L. However, it would be equally possible for the diffusion resistance layer 32 to be positioned opposite the first main surface 301 of the solid electrolyte layer 31, facing the detection gas chamber 35 from the tip end, along the longitudinal direction L. Furthermore it would be equally possible for the diffusion resistance layer 32 to be laminated on the first main surface 301 of the solid electrolyte layer 31 via the first insulating layer 33A, and to be arranged at a position facing the first main surface 301 of the solid electrolyte layer 31 via the detection gas chamber 35.

The diffusion resistance layer 32 is formed of an insulating metal oxide such as alumina, as for the first and second insulating layers 33A and 33B. The diffusion resistance layer 32 is formed as a porous layer having a plurality of pores for introducing the detection gas G into the detection gas chamber 35 at a predetermined diffusion rate. The density of the diffusion resistance layer 32 is less than those of the first and second insulating layers 33A and 33B.

As shown in FIGS. 2 and 3, the air duct 36, into which air is introduced as the reference gas A, is surrounded by the second insulating layer 33B and is formed adjacent to the second main surface 302 of the solid electrolyte layer 31. The air duct 36 is formed extending from a base end position, with respect to the longitudinal direction L of the sensor element body 2, to a position facing the detection gas chamber 35 via the solid electrolyte layer 31. The reference electrode 312 is disposed at the tip end in the air duct 36.

The porous layer 37 is formed of alumina as a metal oxide. The porous layer 37 has a plurality of pores for capturing substances that are poisonous to the detection electrode 311, and capturing water condensate that is produced in the exhaust pipe. The porosity of the porous layer 37 is greater than that of the diffusion resistance layer 32, and the flow rate at which the detection gas G can pass through the porous layer 37 is greater than the flow rate at which the detection gas G that can pass through the diffusion resistance layer 32. It should be noted that “porosity” refers to the proportion occupied by pores (voids) per unit volume.

The porous layer 37 is formed by aggregating a plurality of particulate metal oxides that have been formed into a maze structure, in which a plurality of pores formed between the plurality of particulate metal oxides obstruct the passage of water. In addition to being made of alumina, the porous layer 37 may be made of a ceramic (metal oxide) containing at least one of alumina, titanic, zirconia, silicon carbide, silicon nitride, spinel, and zinc oxide.

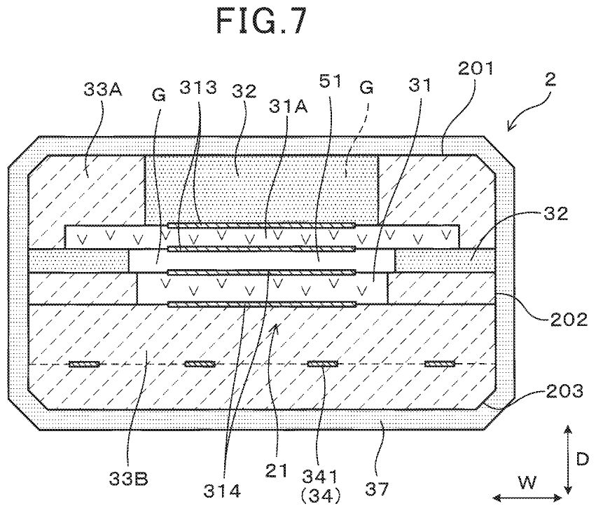

The sensor element body 2 of the present embodiment has a single solid electrolyte layer 31 and an air duct 36. However, it would be equally possible for the sensor element body 2 to have two solid electrolyte layers 31A and 31B and no air duct 36, for example, as shown in FIG. 7. In that case, a pair of electrodes 315 provided on the first solid electrolyte layer 31A are used for adjusting the oxygen concentration of the detection gas G in the detection gas chamber 35, and a pair of electrodes 316 provided on the second solid electrolyte layer 31B are used to detect the oxygen concentration of the detection gas G in the detection gas chamber 35. In this case also, the heater element 34, the porous layer 37, etc., can be provided in the same manner as shown in the case of FIG. 3.

As shown in FIGS. 3 and 4, the sensor element body 2 of the present embodiment is formed in a shape that is substantially square, as viewed in cross-section orthogonal to the longitudinal direction L. The sensor element body 2 has four surfaces along the longitudinal direction L, consisting of a pair of first flat surfaces 201 that are parallel to the first main surface 301 and the second main surface 302, and a pair of second flat surfaces 202 that are orthogonal to the first main surface 301 and the second main surface 302. In addition, tapered surfaces 203 are formed by chamfering each of the four corners 22 between the pair of first flat surfaces 201 and the pair of second flat surfaces 202. It should be noted that it would be equally possible for the corners 22 to be formed with a curved shape, instead of the tapered surfaces 203.

The porous layer 37 is formed continuously with the pair of first flat surfaces 201, the pair of second flat surfaces 202, and the four tapered surfaces 203. The porous layer 37 can be formed by immersing the sensor element body 2 in a paste material containing a metal oxide and a solvent, to form the porous layer 37, then taking out the sensor element body 2 and drying the paste material that is attached thereto. Alternatively, the porous layer 37 can be formed by ejecting a paste material onto the sensor element body 2, then drying the ejected paste material.

Due to the manufacturing method, it is difficult to form the porous layer 37 such as to be uniform overall. Hence the thickness of the porous layer 37 is expressed by the average thickness Y. The average thickness Y of the porous layer 37 can be taken as the average Y of the thickness of the porous layer 37 measured on the pair of first flat surfaces 201, on the pair of second flat surfaces 202, and on the four tapered surfaces 203. The thickness of the porous layer 37 may be taken as the average Y of the thickness of the porous layer 37 measured at each of a plurality of positions on each of the pair of first flat surfaces 201,the pair of second flat surfaces 202, and the four tapered surfaces 203. For example, the thickness of the porous layer 37 may be measured at each of 10 positions on each of the surfaces 201, 202 and 203, and the average value of these measured thickness values at each surfaces 201, 202 and 203 can be taken as the average thickness Y of the porous layer 37.

The porous layer 37 of this embodiment is disposed around the entire periphery of the tip end part of the sensor element body 2. However, it would be equally possible for the porous layer 37 to be provided only around the exposed surface 321 of the diffusion resistance layer 32 such as to cover that exposed surface 321. In that case it can be expected that the average thickness Y of the porous layer 37 will become smaller.

### (Other Configuration of Gas Sensor 1)

As shown in FIG. 1, in addition to the sensor element body 2 etc., the gas sensor 1 is provided with a first insulator 42 holding the sensor element body 2, a housing 41 holding the first insulator 42, a second insulator 43 that is linked to the first insulator 42, and contact terminals 44 which are in contact with the sensor element body 2 that is held by the second insulator 43. The gas sensor 1 also includes a tip end cover 45 that is attached to a tip end portion of the housing 41, a base end cover 46 that is attached to a base end portion of the housing 41 and which covers the second insulator 43, the contact terminal 44, etc., and a bush 47, etc., for holding lead wires 48 within the base end cover 46, with the lead wires 48 being connected to the contact terminals 44.

The tip end cover 45 is disposed in the exhaust pipe of an internal combustion engine. A gas passage hole 451 is formed in the tip end cover 45, for allowing passage of exhaust gas as the detection gas G. The tip end cover 45 may have a double-wall structure or a single-wall structure. Exhaust gas which flows as the detection gas G into the interior of the tip end cover 45, through gas passage holes 451 of the tip end cover 45, passes through the porous layer 37 and the diffusion resistance layer 32 of the sensor element body 2 and is introduced to the detection electrode 311.

As shown in FIG. 1, the base end cover 46 is disposed outside a cylinder of the internal combustion engine. An air introduction hole 461 is formed in the base end cover 46, for introducing atmospheric air into the base end cover 46, as the reference gas A. The air introduction hole 461 is provided with a filter 462 which blocks the passage of liquid but allows gas to pass therethrough. The reference gas A that is introduced into the base end cover 46 from the air introduction hole 461 passes through a gap in the base end cover 46 and the air duct 36 and is then introduced to the reference electrode 312.

A plurality of contact terminals 44 are arranged on the second insulator 43, respectively connected to the electrode lead 313 of the detection electrode 311, the electrode lead 314 of the reference electrode 312, and the heater element lead 342 of the heater element 34. Lead wires 48 are connected to respective ones of the contact terminals 44.

As shown in FIG. 1, the lead wires 48 of the gas sensor 1 are electrically connected to the sensor control unit 6. The sensor control unit 6 performs electrical control of the gas sensor 1 in cooperation with the engine control unit. A measurement circuit for measuring the current flowing between the detection electrode 311 and the reference electrode 312, an application circuit for applying a voltage between the detection electrode 311 and the reference electrode 312, and an energizing circuit for energizing the heater element 34, etc., are formed in the sensor control unit 6. It should be noted that it would be possible for the sensor control unit 6 to be constituted in the engine control unit.

The power supply device 5 of the present embodiment is constituted by the energization circuit formed in the sensor control unit 6. The energization circuit is configured to adjust the applied power amount P that is applied to the heater element 34. The applied power amount P is varied appropriately by the energization circuit for heating the detection section 21 of the gas sensor 1 in accordance with the target temperature and the average thickness Y of the porous layer 37. The applied power amount P [] is expressed as the product of the voltage [V] applied to the heater element 34 and the current [A] that flows through the heater element 34.

The power supply device 5 can adjust the amount of power P supplied to the heater element 34 by changing the voltage applied between the pair of heater element leads 342 of the heater element 34. The supplying of power to the heater element 34 by the power supply device 5 can be performing by PWM (pulse width modulation) or the like.

(First relational Expression R1 Between Applied Power Density X and Average Thickness Y of Porous Layer 37)

The first relational expression R1 of the present embodiment indicates the value of average thickness Y of the porous layer 37 that is the minimum for maintaining the accuracy of detecting the inter-cylinder imbalance at a predetermined level, and was derived based on experiments for measuring the fluctuation in output of the gas sensor 1 when the applied power density X and the average thickness Y of the porous layer 37 were changed, with wetting of the porous layer 37 being taken into consideration.

Fluctuation of the output from the gas sensor 1 occurs due to a decrease in the temperature of the detection section 21 that is caused by the porous layer 37 of the sensor element body 2 becoming wetted. It is assumed that the rate of change of the output from the gas sensor 1 of the present embodiment increases in proportion to decrease in the temperature of the detection section 21. Furthermore, the output fluctuation of the gas sensor 1 indicates the accuracy of detecting cylinder imbalance. The accuracy of detecting cylinder imbalance refers to the capability for detecting the air-fuel ratio of exhaust gas produced from each cylinder separately from the air-fuel ratios of the exhaust gas produced from the other cylinders. In an internal combustion engine having a plurality of cylinders, the four strokes of intake, compression, combustion, and exhaust are each performed at different timings for each of the cylinders. The exhaust gas produced from each cylinder in turn thus flows sequentially to the exhaust pipe of the internal combustion engine.

In the present embodiment, to determine the accuracy of detecting the inter-cylinder imbalance, the air-fuel ratio in one of the cylinders was made different from the air-fuel ratios in the other cylinders. The amplitude (difference between the maximum value and the minimum value) of the waveform of the output value of the gas sensor 1 in one combustion cycle, in which four strokes are performed in all of the cylinders, was then obtained as an imbalance response value. The variation period of the waveform of the output from the gas sensor 1 is equal to one combustion cycle of the internal combustion engine.

The imbalance response value changes such as to become better (higher) in accordance with increase in the temperature of the detection section 21 of the gas sensor 1. Furthermore, with the present embodiment, the imbalance response value increases in proportion to increase in the temperature of the detection section 21. Moreover, the smaller the average thickness Y of the porous layer 37, the greater becomes the extent to which the temperature of the detection section 21 is lowered.

In the gas sensor 1 of the present embodiment, the amount P of electric power supplied to the heater element 34 by the power supply device 5 is determined such as to make the temperature of the detection section 21 become 700° C., as the target temperature. The imbalance response value is 100%, when the temperature of the detection section 21 is 700° C., and when the temperature of the detection section 21 becomes lower than 700° C., the imbalance response value deteriorates, becoming less than 100%. On the other hand, when the temperature of the detection section 21 is higher than 700° C., the imbalance response value exceeds 100%, becoming improved.

The evaluation reference value of the imbalance response value, for evaluating the quality of the accuracy of detecting the inter-cylinder imbalance when the imbalance response value deteriorates within a range of 5 to 10%, was set for the case of deterioration within the range 4.5 to 10.5%, to take into account an error range of ±0.5%. In other words, this evaluation reference value applies to the case in which the imbalance response value is within the range of 89.5 to 95.5%. The first relational expression R1 was obtained by varying the applied power density X and the average thickness Y of the porous layer 37, and performing regression analysis of the data obtained for the cases when the imbalance response value was within the range of 89.5 to 95.5%.

FIG. 8 shows the relationship between the applied power density X and the average thickness Y of the porous layer 37. The average thickness Y of the porous layer 37 when the applied power density X is substituted in the first relational expression R1 is set as the reference value of the average thickness Y. In evaluating the accuracy of detecting the inter-cylinder imbalance, if the average thickness Y of the porous layer 37 is equal to greater than the reference value of average thickness Y when the applied power density X has been specified, it is assumed that the inter-cylinder imbalance detection accuracy satisfies the required detection accuracy. The first relational expression R1 expresses the relationship between the reference value of average thickness Y of the porous layer 37 and variation of the applied power density X.

With regard to the relationship between the temperature of the detection section 21 and the imbalance response value, when the temperature of the detection section 21 decreases by 10° C., the imbalance response value is reduced by approximately 6%, and when the temperature of the detection section 21 decreases by 30° C., the imbalance response value is reduced by approximately 18%. When the imbalance response value is within the range of 89.5 to 95.5%, the temperature of the detection section 21 is lowered by approximately 7.5 to 17.5° C.

When obtaining the imbalance response value by varying the applied power density X and the average thickness Y of the porous layer 37, the rotation speed of the internal combustion engine was set to 1600 rpm (26.7 rps), and the gas flow rate per unit cross-sectional area of the exhaust pipe was adjusted to 20 g/s. The fuel injection amount supplied to one of the plurality of cylinders (four in the present embodiment) of the internal combustion engine was increased, relative to the fuel injection amounts of the remaining cylinders. With the present embodiment, the fuel injection amount of the one of the cylinders was increased by 40%, thereby shifting the air-fuel ratio of that cylinder to the fuel-rich side with respect to the stoichiometric air-fuel ratio, while the air-fuel ratios of the remaining cylinders were set to the stoichiometric air-fuel ratio.

With the first relational expression R1 of FIG. 8, when the applied power density X becomes approximately 0.29 [W/mm³], the reference value of the average thickness Y of the porous layer 37 reaches a minimum of approximately 92.4 [μm]. When the applied power density X is less than approximately 0.29 [W/mm ] then as the applied power density X decreases, the reference value of the average thickness Y of the porous layer 37 increases in accordance with the decrease of the applied power density X. Furthermore, when the applied power density X is greater than about 0.29 [W/mm³], the reference value of the average thickness Y of the porous layer 37 increases in accordance with increase of the applied power density X.

The temperature of the detection section 21, which determines the quality of the imbalance response value, varies in accordance with the heat balance between the amount of heat received by the detection section 21 and the amount of heat released from the detection section 21. The amount of heat received by the detection section 21 is affected in particular by the applied power density X that is applied from the heating section 341 of the heater element 34 to the detection section 21 of the sensor element body 2. As the applied power density X increases, the amount of heat received by the detection section 21 increases. The amount of heat received by the detection section 21 is also affected by the thickness of respective parts of the sensor element body 2, the thermal conductivity of each part, etc. The greater the thickness of each part in the sensor element body 2, the higher becomes the heat capacity of each part and the smaller becomes the amount of heat received by the detection section 21. Furthermore, as thermal conductivity of each part in the sensor element body 2 increases, the heat conduction in each part improves, and the amount of heat received by the detection section 21 increases accordingly.

On the other hand, the amount of heat released from the detection section 21 is particularly increased by evaporation heat (heat of vaporization), when the porous layer 37 covering the detection section 21 has become wet, and water that adheres to the surface of the porous layer 37 evaporates. As the heat of evaporation increases, the amount of heat released from the detection section 21 increases accordingly. Furthermore, the amount of heat released from the detection section 21 is affected by the average thickness Y of the porous layer 37. It can be considered that as the average thickness Y of the porous layer 37 increases, and the heat capacity of the porous layer 37 increases accordingly, the heat retention effect of the porous layer 37 is promoted and so that the amount of heat released from the detection section 21 will decrease.

The amount of heat released from the detection section 21 is also affected by the thickness of each part of the sensor element body 2 and thermal conductivity, etc., of these parts. It can be considered that as the thickness of each part of the sensor element body 2 increases, the heat capacity of each part increases accordingly, and the amount of heat released from the detection section 21 decreases. It can also be considered that as thermal conductivity of each part of the sensor element body 2 increases, the amount of heat released from the detection section 21 is thereby increased.

The relationship between the applied power density X and the average thickness Y of the porous layer 37 in the first relational expression R1 has been obtained based on actual measurement, however the reason why the first relational expression R1 is obtained is not necessarily apparent. According to the relationship expressed by the first relational expression R1, when the applied power density X is less than about 0.29 [W/mm³], the smaller the average thickness Y of the porous layer 37, the greater becomes the effect of wetness on the temperature of the detection section 21, and the greater becomes the amount of heat released from the detection section 21. In that case, the relationship can be considered to be such that as the applied power density X decreases, the average thickness Y of the porous layer 37 must be increased.

On the other hand, the reason why the relationship of the first relational expression R1 is obtained when the applied power density X is greater than about 0.29 [W/mm³] may not be apparent. The reason is that it can be considered that if, for example, the applied power density X becomes excessively great, the heat of evaporation in the porous layer 37 becomes increased, and a relationship is formed whereby the greater the applied power density X, the greater must be made the average thickness Y of the porous layer 37.

It can be considered that the applied power density X supplied to the heater element 34 of the sensor element body 2 which is optimal for reducing the average thickness Y of the porous layer 37 is approximately 0.29 [W/mm³].

### (Second to Fourth Relational Expressions R2, R3, R4 Between Applied Power Density X and Average Thickness Y of Porous Layer 37)

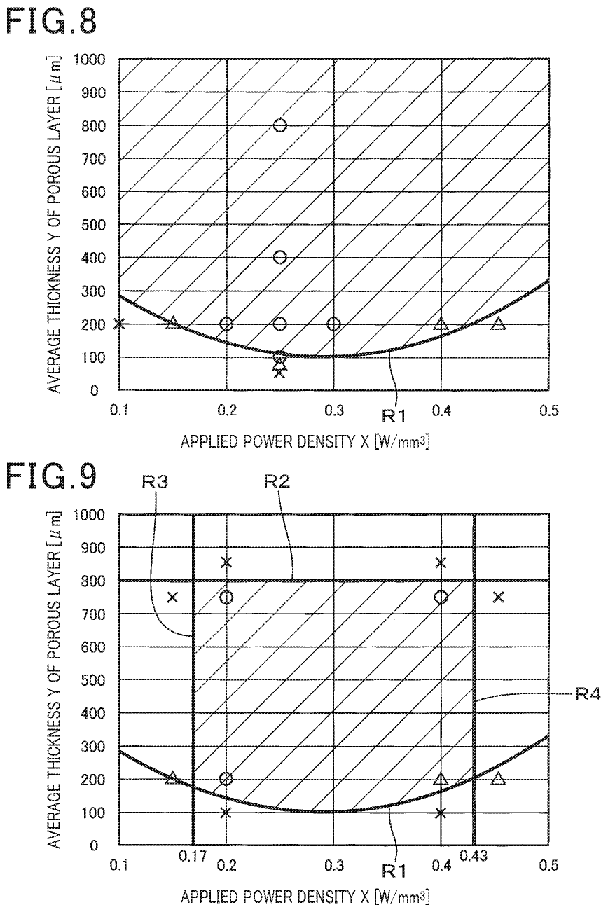

As shown in FIG. 9, it is desirable for the relationship between the applied power density X and the average thickness Y of the porous layer 37 to also satisfy the following second to fourth relational expressions R2, R3, and R4.

If the average thickness Y of the porous layer 37 is too large, the heat capacity of the porous layer 37 increases, and the responsiveness of the gas sensor 1 becomes lowered. The responsiveness of the gas sensor 1 is expressed by a response time, which is the time from a change in the air-fuel ratio of the exhaust gas until that change is detected by the gas sensor 1.

The response time of the gas sensor 1 is set as a 63% response time, which is the time from the point when the air-fuel ratio of the exhaust gas changes until the gas sensor 1 detects 63% of the change. Taking the 63% response time of an existing the gas sensor 1, which is 600 ms, as a reference value, it was determined that satisfactory responsiveness of the gas sensor 1 is ensured so long as the 63% response time is less than the reference value. As shown in FIG. 9, if the average thickness Y [μm] of the porous layer 37 satisfies the second relational expression R2 of Y≤800, the response time of the gas sensor 1 becomes equal to or less than the reference time, and satisfactory responsiveness (response time) is ensured.

If the applied power density X is excessively low when the detection section 21 of the sensor element body 2 is being heated by the heating section 341 of the heater element 34, an increased time is required to reach the activation temperature at which the sensor characteristic is expressed, and hence early activation of the gas sensor 1 becomes difficult. Early activation is expressed by the activation time of the gas sensor 1.

The activation time of the gas sensor 1 is defined as the time from the commencement of power supply to the heater element 34 is until the temperature of the detection section 21 reaches 600° C., as the predetermined activation temperature. The reference value of activation time of the gas sensor 1 is set as 5 s, which is the activation time of the existing gas sensor 1, and the activation time is judged to be satisfactory if it is shorter than the reference value. As shown in FIG. 9, if the applied power density X [W/mm³] satisfies the third relational expression R3 of 0.17≤X, the activation time of the gas sensor 1 becomes equal to or less than the reference time, so that early activation of the gas sensor 1 is ensured.

If the applied power density X is excessively great when the detection section 21 of the sensor element body 2 is being heated by the heating section 341 of the heater element 34, then there is a heightened possibility that the heating section 341 will become disconnected due to the amount of generated heat. It has been confirmed that disconnection of the heating section 341 occurs when the applied power density X exceeds a predetermined value. Specifically, it was confirmed that disconnection of the heating section 341 occurred when the applied power density X exceeded 0.45 [W/mm³]. Hence as shown in FIG. 9, if the applied power density X [W/mm³] satisfies the fourth relational expression R4 of X≤0.43, satisfactory durability of the heating section 341 is ensured, without occurrence of disconnection.

### (Operations and Effects)

With the gas sensor 1 according to the present embodiment, an index is provided for determining the range of values in which the average thickness Y of the porous layer 37 should be set, in relation to the applied power density X that is applied to the heater element 34 by the power supply device 5. The gas sensor 1 of the present embodiment also provides an index for determining the range of values within which the applied power density X should be set.

This index is expressed by the first to fourth relational expressions R1, R2, R3, R4, which determine the applied power density X and the average thickness Y of the porous layer 37. The first to fourth relational expressions R1, R2, R3, and R4 of the present embodiment also take wetting of the porous layer 37 into account, and have been derived by conducting experiments.

In addition, the first relational expression R1 defines a lower limit to the value that the average thickness Y of the porous layer 37 may take, in relation to the applied power density X, consistent with maintaining sufficient accuracy of detecting the inter-cylinder imbalance by the gas sensor 1. If the applied power density X and the average thickness Y of the porous layer 37 are set to satisfy the first relational expression R1, the temperature of the detection section 21 in the sensor element body 2 can be appropriately maintained, and high accuracy of detecting the inter-cylinder imbalance can be ensured.

Hence the gas sensor 1 of the present embodiment can provide index which enables determination of the minimum thickness that is allowable for the porous layer 37, in relation to the applied power density X, consistent with maintaining a high accuracy of detecting the inter-cylinder imbalance.

Furthermore, with the gas sensor 1 of the present embodiment, the applied power density X and the average thickness Y of the porous layer 37 are determined such to satisfy not only the first relational expression R1 but also the second to fourth relational expressions R2, R3, and R4. As a result, satisfactory responsiveness (response time) of the gas sensor 1, early activation (activation time) of the gas sensor 1, and durability of the heater element 34 can be ensured. By satisfying the first to fourth relational expressions R1, R2, R3, and R4, a gas sensor 1 having excellent characteristics can be constituted. Furthermore once the applied power density X that is to be applied to the heater element 34 of the gas sensor 1 has been determined, it becomes possible to ascertain the range of values within which the average thickness Y of the porous layer 37 should be set, for ensuring an appropriate value of the average thickness Y.

In addition, once the applied power density X that is to be applied to the heater element 34 has been determined, the first to fourth relational expressions R1, R2, R3, and R4 can serve in a method of manufacturing of the gas sensor 1, for determining the average thickness Y of the porous layer 37. Alternatively, once the average thickness Y of the porous layer 37 has been determined, the first to fourth relational expressions R1, R2, R3, and R4 can serve in a method of using the gas sensor 1, for determining the applied power density X that is to be applied to the heater element 34.

The porous layer 37 in this embodiment is formed entirely of the same type of ceramic (metal oxide), in order to have the same porosity throughout. However, it would be equally possible for a part of the porous layer 37 to be formed of a different ceramic from the other parts. Furthermore, the porosity of a part of the porous layer 37 may be made different from the porosity of the other parts. For example, the portion of the porous layer 37 disposed on the exposed surface 321 of the diffusion resistance layer 32 may have a different material, a different porosity, or etc., than the parts of the porous layer 37 which are disposed elsewhere. Furthermore, it would be possible to dispose two porous layers 37 having mutually different porosities on the exposed surface 321 of the diffusion resistance layer 32.

### <Confirmation Test 1>

In Confirmation test 1, to derive the first relational expression R1, the applied power density X and the average thickness Y of the porous layer 37 were varied appropriately for measuring the amounts of reduction in the imbalance response value, which expresses the accuracy of detecting the inter-cylinder imbalance. The applied power density X was varied within the range of 0.1 to 0.45 [W/mm³], and the average thickness Y of the porous layer 37 was varied within the range of 50 to 800 [μm].

Table 1 shows the results of measuring the amount of decrease in the imbalance response value. In that table, samples of the gas sensor 1 for which the respective values of applied power density X or of average thickness Y of the porous layer 37 were varied appropriately are designated as “1-1” to “1-12” respectively.

TABLE 1

| | | AVERAGE | AMOUNT OF | |
|---|---|---|---|---|
| | APPLIED | THICKNESS | DECREASE OF | |
| | POWER | Y OF | IMBALANCE | |
| | DENSITY | POROUS | RESPONSE | |
| | X | LAYER | VALUE | |
| | [W/mm³] | [μm] | [%] | JUDGEMENT |
| 1-1 | 0.25 | 50 | 33.1 | x |
| 1-2 | | 75 | 8.9 | Δ |
| 1-3 | | 100 | 4.4 | ∘ |
| 1-4 | | 200 | 3.2 | ∘ |
| 1-5 | | 400 | 1.0 | ∘ |
| 1-6 | | 800 | 0.0 | ∘ |
| 1-7 | 0.1 | 200 | 11.5 | x |
| 1-8 | 0.15 | | 7.3 | Δ |
| 1-9 | 0.20 | | 3.2 | ∘ |
| 1-10 | 0.30 | | 3.2 | ∘ |
| 1-11 | 0.40 | | 4.7 | Δ |
| 1-12 | 0.45 | | 10.3 | Δ |

Taking into consideration an error range of ±0.5% when the reduction of the imbalance response value is in the range of 5 to 10%, the amounts of decrease in the imbalance response value which were within the range of 4.5 to 10.5% was used as the data for deriving the first relational expression R1. In this case, the evaluation reference value of the imbalance response, value when discriminating between good and bad accuracy of detecting the inter-cylinder imbalance, is indicated by A in the judgments of Table 1.

In FIG. 8, in the relationship between the applied power density X and the average thickness Y of the porous layer 37, the symbol A indicates the cases in which the degree of decrease in the imbalance response value is within the range of 4.5 to 10.5%. The first relational expression R1 was derived as a result of performing regression analysis for the four points indicated by the symbol A.

Furthermore in Table 1, the cases in which the amount of decrease in the imbalance response value was less than 4.5% when the applied power density X and the average thickness Y of the porous layer 37 were varied are indicated by the ◯ symbol, as being cases in which the accuracy of detecting the inter-cylinder imbalance is good. The cases in which the amount of decrease in the imbalance response value was greater than 10.5% are indicated by the × symbol, as being cases in which the accuracy of detecting the inter-cylinder imbalance is poor. In FIG. 8 also, these cases are similarly indicated by the ◯ and × symbols. The hatched region in that figure indicates the range within which the first relational expression R1 is satisfied.

As shown by the results of confirmation test 1, a high accuracy of detecting the inter-cylinder imbalance can be ensured if the first relational expression R1 is satisfied, where the first relational expression R1 is derived by performing regression analysis on the relationship between the applied power density X and the average thickness Y of the porous layer 37 in the gas sensor 1. <Confirmation Test 2>

In Confirmation test 2, to derive the second to fourth relational expressions R2, R3 and R4, the applied power density X and the average thickness Y of the porous layer 37 were appropriately varied, and the amounts of decrease in the imbalance response value, the responsiveness of the gas sensor 1 (63% response time), the early activation of the gas sensor 1 (activation time), and the durability of the heater element 34 (whether or not the heating section 341 became disconnected) were measured. The applied power density X was varied within the range of 0.15 to 0.45 [W/mm³], and the average thickness Y of the porous layer 37 was varied within the range of 100 to 850 [μm].

Table 2 shows the results of measurement of the amount of decrease in the imbalance response value, the 63% response time, the activation time, and the presence or absence of disconnection. In that table, samples of the gas sensor 1 for which the applied power density X or the average thickness Y of the porous layer 37 were appropriately varied are designated as “2-1” to “2-12” respectively.

TABLE 2

| | | | AMOUNT OF | | | | | |
|---|---|---|---|---|---|---|---|---|
| | APPLIED | AVERAGE | DECREASE OF | | | | | |
| | POWER | THICKNESS Y OF | IMBALANCE | | | | PRESENCE/ | |
| | DENSITY X | POROUS LAYER | RESPONSE VALUE | | 63% RESPONSE | ACTIVATION | ABSENCE OF | OVERALL |
| | [W/mm³] | [μm] | [%] | | TIME | TIME | DISCONNECTION | JUDGEMENT |
| 2-1 | 0.15 | 200 | 7.3 | Δ | ∘ | x | ∘ | x |
| 2-2 | 0.20 | 200 | 3.2 | ∘ | ∘ | ∘ | ∘ | ∘ |
| 2-3 | 0.20 | 100 | 33.4 | x | ∘ | ∘ | ∘ | x |
| 2-4 | 0.15 | 750 | 0.8 | ∘ | ∘ | x | ∘ | x |
| 2-5 | 0.20 | 750 | 0.5 | ∘ | ∘ | ∘ | ∘ | ∘ |
| 2-6 | 0.20 | 850 | 0.1 | ∘ | x | ∘ | ∘ | x |
| 2-7 | 0.40 | 200 | 4.7 | Δ | ∘ | ∘ | ∘ | ∘ |
| 2-8 | 0.40 | 100 | 21.3 | x | ∘ | ∘ | ∘ | x |
| 2-9 | 0.45 | 200 | 10.3 | Δ | MEASUREMENT | MEASUREMENT | x | x |
| | | | | | IMPOSSIBLE | IMPOSSIBLE | | |
| 2-10 | 0.40 | 750 | 0.2 | ∘ | ∘ | ∘ | ∘ | ∘ |
| 2-11 | 0.40 | 850 | 0.1 | ∘ | ∘ | ∘ | ∘ | x |

| | | | | | | | |
|---|---|---|---|---|---|---|---|
| 2-12 | 0.45 | 750 | MEASUREMENT | MEASUREMENT | MEASUREMENT | x | x |
| | | | IMPOSSIBLE | IMPOSSIBLE | IMPOSSIBLE | | |

### (Decrease in Imbalance Response Value)

In the judgments of Table 2, a case in which the amount of decrease of the imbalance response value is less than 4.5% is indicated by a ◯ symbol, showing that the accuracy of detecting the inter-cylinder imbalance is good. On the other hand, a case in which the amount of decrease of the imbalance response value exceeds 10.5% is indicated by a × symbol, showing that the accuracy of detecting the inter-cylinder imbalance is poor. A case in which the amount of decrease in the imbalance response value is within the range of 4.5 to 10.5% is indicated by a Δ symbol. Cases in which the amount of decrease in the imbalance response value could not be measured are also shown.

The results of measuring the amounts of decrease of the imbalance response value show that a judgment result of “×” was obtained for the case in which the applied power density X was 0.2 W/mm³ and the average thickness Y of the porous layer 37 was 100 μm, and for the case in which the applied power density X was 0.4 W/mm³ and the average thickness Y of the porous layer 37 was 100 μm. The other measurement results are the same as in the case of the confirmation test 1. It was confirmed that when a porous layer 37 is provided in the sensor element body 2, the minimum allowable value of average thickness Y [μm] of the porous layer 37 can be determined based on the first relational expression R1.

### (63% Response Time)

In the judgments of Table 2, cases in which the 63% response time is 600 ms or less, which is the value obtained with the existing gas sensor 1, are indicated by a ◯ symbol, as being cases in which the responsiveness is good. On the other hand, cases in which the 63% response time exceeds the value of 600 ms obtained with the existing gas sensor 1 are indicated by a × symbol, as being cases in which the responsiveness is poor. Cases in which 63% response time could not be measured are also shown.

In the 63% response time measurement results, the judgment result was “×” when the average thickness Y of the porous layer 37 was 850 μm, and the judgment result was “◯” when the average thickness Y of the porous layer 37 was 750 μm. In addition, it has been learned from data analysis that when the average thickness Y of the porous layer 37 is between 750 μm and 850 μm, at 800 μm, there is a reference value for judging the quality of the 63% response time. The second relational expression R2 of Y≤800 was obtained from this result, as the maximum allowable value of average thickness Y [μm] of the porous layer 37 when it is disposed on the sensor element body 2.

### (Activation Time)

In the judgments of Table 2, cases in which the activation time is 5 s or less, which is the value obtained with the existing gas sensor 1, are indicated by a ◯ symbol as being cases in which the early activation is good. On the other hand, cases in which the activation time exceeds the value of 5 s obtained with the existing gas sensor 1 are indicated by a × symbol, as being cases in which the early activation is poor. Cases in which the activation time could not be measured are also shown.

In the results of measuring the activation time, the judgment result was “×”, when the applied power density X was 0.15 W/mm³, and the judgment result became “◯” when the applied power density X was 0.2 W/mm³ or more. Furthermore, it was learned by analyzing the data that an applied power density X of 0.17 W/mm³, between 0.15 and 0.2 W/mm³, is a reference value for judging the quality of the activation time. From this result, a third relational expression R3 of 0.17≤X was obtained as the minimum allowable value of the applied power density X applied to the heater element 34.

### (Presence/Absence of Disconnection)

In addition, in the judgments of Table 2, cases in which no disconnection occurred in the heating section 341 are indicated by a ◯ symbol, as being cases in which the durability of the heat generating element 34 is good. On the other hand, cases in which the heating section 341 became disconnected are indicated by a × symbol, as being cases in which the durability of the heat generating element 34 is poor.

In the results of measuring the presence/absence of disconnection, the judgment result was “×” when the applied power density X was 0.45 W/mm³, and became “◯” when the applied power density X is 0.4 W/mm³ or less. Furthermore, it was learned by analyzing the data that an applied power density X of 0.43 W/mm³, between 0.4 W and 0.45 W/mm³, is a reference value for judging the presence/absence of disconnection. From this result, a fourth relational expression R4 of X≤0.43 was obtained, as the maximum allowable value of applied power density X to be applied to the heater element 34.

### (Overall Judgment)

In the overall judgment results in Table 2, the cases in which the judgment results obtained for the amount of decrease of the imbalance response value, for the 63% response time, for the activation time and for the presence/absence of disconnection are all good are indicated by the ◯ symbol, while if any of these results is poor then that is indicated by the × symbol for the overall judgment. Similarly, in the graph of FIG. 9 showing the relationship between the applied power density X and the average thickness Y of the porous layer 37, the results of the overall judgment are indicated by the ◯ and × symbols. In that diagram, the range within which the first to fourth relational expressions R1, R2, R3, and R4 are satisfied is shown by hatching.

As shown in the results of Confirmation Test 2, when the first to fourth relational expressions R1, R2, R3, and R4 concerning the relationship between the applied power density X and the average thickness Y of the porous layer 37 in the gas sensor 1 are satisfied, then not only can the accuracy of detecting the inter-cylinder imbalance be maintained at a high level, but also the responsiveness of the gas sensor 1, early activation of the gas sensor 1, and the durability of the heater element 34 can be maintained at a high level.

### Other Embodiments

The present disclosure is not limited to the embodiments, and different embodiments may be configured without departing from the gist of the present disclosure. The present disclosure focuses in particular on the relationship between the applied power density X and the average thickness Y of the porous layer 37 of a laminated type of sensor element body 2, however the configurations of the gas sensor 1, the sensor element body 2, etc., may be changed as appropriate. Furthermore, the scope of the present disclosure includes various modified examples, modified examples that are within a scope of equivalents, etc.

What is claimed is:

1. A gas sensor comprising:
a sensor element body comprising a solid electrolyte layer, a detection electrode provided on a first main surface of the solid electrolyte layer, a reference electrode provided on a second main surface of the solid electrolyte layer, a detection gas chamber formed adjacent to the first main surface of the solid electrolyte layer and disposing the detection electrode therein, a diffusion resistance layer that is laminated on the solid electrolyte layer, for introducing a detection gas into the detection gas chamber, insulating layers laminated on the solid electrolyte layer, a heater element that is embedded in the insulating layers and that generates heat when energized, and a porous layer that covers at least an exposed surface of the diffusion resistance layer; and
a power supply device for energizing the heater element;
wherein when gas detection is being performed by the gas sensor in a steady state, designating the amount of power being applied to the heater element by the power supply device as P [W], designating the volume of the length range of a heating region of the heater element provided in the sensor element body as V [mm³], and designating the applied power density as X [W/mm³], where X is a value expressed by P/V, the following relationship between the applied power density X and the average thickness Y [μm] of the porous layer is satisfied:
Y≥509.32−2884.89X+5014.12X²

2. The gas sensor according to claim 1, wherein
the average thickness Y [μm] of he porous layer further satisfies the relational expression of Y≤800, and
the applied power density X [W/mm³] satisfies the relational expression of 0.17≤X≤0.43.

3. The gas sensor according to claim 1, wherein
an air duct, which is surrounded by the insulating layer and through which air is introduced, is formed on the second main surface of the solid electrolyte layer, and
the reference electrode is disposed within the air duct.

4. The gas sensor according to claim 1, wherein:
the sensor element body is formed with an elongated shape, with the detection electrode, the reference electrode and the heating region at a tip end position with respect to the longitudinal direction, and having four faces extending along the longitudinal direction, comprising a pair of first flat surfaces that are parallel to the first main surface and the second main surface, and a pair of second flat surfaces that are orthogonal to the first main surface and the second main surface;
the porous layer is formed continuously with the pair of first flat surfaces and the pair of second flat surfaces, and
the average thickness Y of the porous layer is obtained as the average thickness Y of the porous layers formed on the pair of first flat surfaces and on the pair of second flat surfaces.

5. The gas sensor according to claim 1, wherein the porous layer comprises pores formed in a ceramic that includes at least one of alumina, titanic, zirconia, silicon carbide, silicon nitride, spinel, and zinc oxide.
